(19) United States
(12) Patent Application Publication
(10) Pub. No.: US 2025/0240212 A1
(43) Pub. Date: Jul. 24, 2025

(54) System and Method of Autoscaling in a Sharded Distributed Ledger

(71) Applicant: Omar Syed, Murphy, TX (US)

(72) Inventor: Omar Syed, Murphy, TX (US)

(21) Appl. No.: 18/421,439

(22) Filed: Jan. 24, 2024

(51) Int. Cl. H04L 41/08; G06F 16/23; H04L 41/0823

(52) U.S. Cl. CPC H04L 41/0886; G06F 16/2379; H04L 41/0836

(57) ABSTRACT

The invention relates to a sharded network of peer-to-peer computers (also called nodes) which process incoming transactions to update a local copy of the state data in a dynamically sharded distributed ledger. Dynamic sharding allows the transaction throughput and storage capacity of the network to increase proportional to the number of nodes in the distributed ledger. The invention describes a method by which the number of nodes in the network are automatically increased or decreased to accommodate the actual usage of the network in terms of transaction throughput and storage capacity.

### BACKGROUND

Dynamic state sharding is a technique described in U.S. patent application Ser. No. 18/545,572 which can be used in distributed ledgers to increase scalability. The innovation divides the network's state into smaller partitions, and distributes the storage and processing of data across different nodes in the network. This results in more parallel processing and increases the transaction throughput of the network as well as the storage capacity. The dynamic sharding innovation disclosed in the mentioned patent application has the unique feature that as more nodes join the network they can immediately contribute to increasing the parallel processing of the network; this is referred to as linear scaling due to the direct relationship between the number of nodes and the processing capacity of the network.

To make the most efficient use of linear scaling the number of nodes in the network should be adjusted based on the usage and demand for transaction throughput and storage requirements. In a decentralized network the nodes contributing compute, memory, storage and bandwidth resources to the network must be compensated to provide an incentive to participate. The compensation is usually in the form of transaction fees paid to the nodes. Matching the number of nodes in the network to the actual usage allows the network to operate at a minimal cost. Having too many nodes in a network with low number of transactions for example would mean an unnecessarily higher cost of operating the network and translate to higher transaction fees. Such a network should reduce the number of nodes to match the actual usage and reduce cost. Likewise, not having enough nodes in a network with high usage can overload the capacity of a node or cause processing delays. Such a network should increase the number of nodes to match the actual usage. Thus, it is critical to have the right number of nodes in the network based on the usage.

One approach would be that manual human intervention is required to monitor the actual usage of the network and make decisions about adding or reducing the nodes in the network. In a decentralized distributed ledger there is no central entity that can decide how many nodes are needed. All decisions in a decentralized network are based on consensus among the peer-to-peer nodes. This presents a challenge to determine a method by which a network of peer-to-peer nodes can come to agreement on the number of nodes the network should have based on the current usage. It would be desirable if the network could automatically make decisions about the desired size of the network without any human intervention. The difficulty in doing this is that the network is composed of many peer nodes where no single node is a leader or has special privileges. Thus any change to the network would require approval from a significant majority of nodes. However, different nodes in the network may be seeing different levels of actual usage and waiting to make changes only after a majority have approved may be too late. A method is needed where the decision to change the size of the network is not only automatic, but also does not require a majority of the nodes to be impacted before the network agrees to make the change.

### SUMMARY

The present invention describes a method which can be used by a network of peer-to-peer nodes to come to agreement on how many nodes are needed to handle the transaction throughput and storage capacity demands and change the number of nodes in the network if the actual usage changes. The method is most effective when dynamic state sharding is used since this allows the network to gain immediate benefit with each node added to the network.

Each node in the network is configured with numbers that specify the maximum transaction rate the node must process as well as the maximum storage capacity the node must provide. These numbers can be determined in a test environment and all nodes joining the network are configured with the same values. Before attempting to join the network, a node can automatically check if the hardware resources it has meets the configured values by running a benchmark program prior to the node joining the network. If the requirements are not met the node does not attempt to join the network.

Each node is capable of monitoring the actual transaction processing rate and actual storage used while actively participating in the network. In addition the node can monitor parameters such as the number of transactions pending in the processing queue and the amount of time transactions are spending in the processing queue. These metrics are used by nodes to come to consensus on increasing or decreasing the size of the network. In addition these metrics can be used by nodes to rate limit the transactions being injected into the network. A transaction received from an external source is an injected transaction; as opposed to being received from another node in the network. When a transaction is rejected, the external source can simply resubmit the transaction at a later time.

In order to rate limit the transactions each node can reject injected transactions based on the internal metrics showing an increased load. The internal metrics are used to determine a tps_load parameter between 0 and 100 with 0 being no load and 100 being maximum load. When the tps_load increases above a preconfigured threshold value such as 50 the node begins to probabilistically reject transactions such that when the tps_load is 100 all injected transactions are rejected. The probability is computed as:

prob_reject=(tps_load−MAX_TPS)/(100-MAX_TPS)

In order for the network to automatically scale the size, all nodes must come to consensus on adding or removing nodes. There are two factors which can cause the network to scale up or down. First is the transaction throughput and second is account storage. Each node periodically makes a local decision of adding more nodes, removing excess nodes or no change based on the current values of internal metrics and configured parameters. Periodically a randomly determined subset of nodes form a committee to vote and produce a receipt to scale the network size. For a receipt to be valid a predetermined majority of nodes in the committee, such as 55% must vote the same way. If a predetermined majority do not vote the same way, but a sufficient number of nodes, such as 70% have voted, then the network size should not be changed. If a valid receipt is created showing that the network size should be increased or decreased, it is gossiped to all nodes in the network. Based on the receipt all nodes come to agreement on scaling the network up, down. If no receipt is produced then the network size is not changed.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 is a Diagram Of A Network Of Nodes Forming A Distributed Ledger. FIG. 1 depicts a network topology for a distributed ledger implementing autoscaling. The diagram illustrates a network 108 that communicates bidirectionally to eight peripheral nodes 102 (Node A through Node H). Although eight nodes are shown as an example, the number of nodes can be higher or lower than this amount shown.

FIG. 2 is a Diagram Of The Components Of A Node. FIG. 2 illustrates an individual node's architecture within a distributed ledger network implementing autoscaling, showing the components and its connectivity. The node 102 comprises one or more program modules 112 and memory storing said program modules 106, with bidirectional communication to the network 108.

FIG. 3 is a Flowchart Of The Main Processing Loop Process. FIG. 3 depicts a flowchart 300 of the main autoscaling processing loop. This illustrates the primary operational cycle of the method of autoscaling that a node undergoes within the distributed ledger network. It includes, but is not limited to: checks for resource adequacy, processing of transactions, decision-making regarding network size adjustments, and the dissemination of consensus receipts to update the network configuration.

FIG. 4 is a Flowchart Of Processing Incoming Transactions. FIG. 4 directly corresponds to FIG. 3, step 308 and shows a flowchart 400 that outlines the procedure for handling incoming transactions. It illustrates the decision-making process using random number generation to determine whether to process or reject a transaction based on predefined rejection probabilities, ensuring efficient network traffic management.

FIG. 5 is a Flowchart Of Determining Size Change. FIG. 5 directly corresponds to step 310 in FIG. 3 and visualizes via flowchart 500 the collective process by which the nodes in a distributed ledger network respond to and implement a decision to change the network's size. This flowchart encapsulates the network's cohesive and systematic approach to scaling adjustments based on consensus-driven decisions.

FIG. 6 is a Flowchart Of The Receipt Creation Process. FIG. 6 directly corresponds to FIG. 3, step 312 and delineates via flowchart 600 the process of creating a consensus receipt by a committee of nodes. It involves the formation of a committee, voting on network size changes, and the generation of a receipt based on majority consensus, exemplifying the decentralized decision-making process in the network.

FIG. 7 is a Flowchart Of The Gossip Receipt Process. FIG. 7 directly corresponds to FIG. 3, step 314 and illustrates via flowchart 700 the procedure for propagating the consensus receipt through the network. This includes checks to determine if a node is the origin of the receipt, the processing of received receipts, and the gossiping mechanism to ensure widespread and efficient dissemination of network scaling decisions.

Each flowchart mentioned above demonstrates a critical aspect of the autoscaling method in a distributed ledger system, demonstrating decentralized decision-making, efficient information dissemination, and dynamic network scalability.

### DETAILED DESCRIPTION

A description of embodiments of the present invention will now be given with reference to the Figures. It is expected that the present invention may be embodied in other specific forms without departing from its spirit or essential characteristics. The described embodiments are to be considered in all respects only as illustrative and not restrictive.

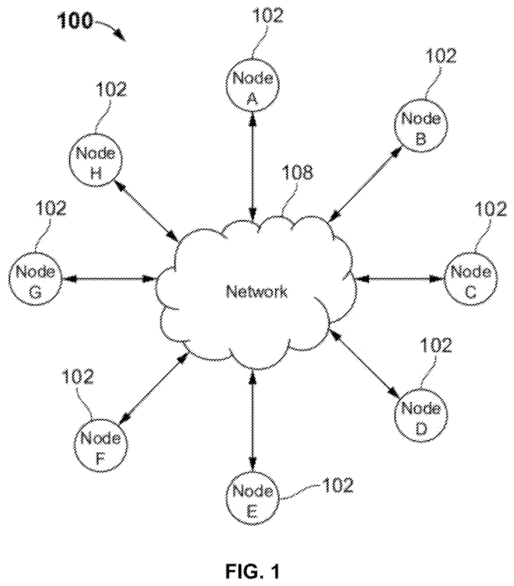

FIG. 1 illustrates an environment 100 of a system for autoscaling in a distributed ledger, according to an embodiment of the present invention. The system is configured to enable each computing node 102 within a network within the network to autonomously perform specific functions. These functions include monitoring actual transaction processing rates and storage usage, determining the need for scaling based on predefined parameters and real-time metrics, achieving consensus with other nodes on scaling decisions through a predetermined protocol, and implementing changes in the network size by either adding or removing nodes as per the consensus agreement.

The environment 100 comprises one or more computing nodes A, B, C, D, E, F, G, H 102 interconnected via a network 108. The computing nodes A, B, C, D, E, F, G, H 102 are generally also referred to as a node/nodes or a computer/computers. The autoscaling system comprises a plurality of computing nodes 102. The plurality of computing nodes 102 are connected to one another via a network. The network 108 generally represents one or more interconnected networks, over which the resources and the computing node 102 could communicate with each other. The network 108 may include packet-based wide area networks (such as the Internet), local area networks (LAN), private networks, wireless networks, satellite networks, cellular networks, paging networks, and the like. A person skilled in the art will recognize that the network 108 may also be a combination of more than one type of network. For example, the network 108 may be a combination of a LAN and the Internet. In addition, the network 108 may be implemented as a wired network, or a wireless network or a combination thereof.

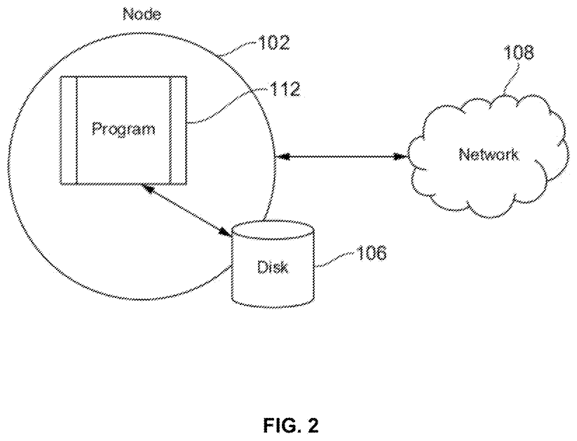

Referring to FIG. 2, the computing node 102 contains a disk 106 and a program module 112. Although not explicitly shown, a node is expected to contain memory to store the program module and a CPU to execute the program module. The node 102 also includes a connection to a network through which it can communicate with other nodes. The computing node 102 is part of a distributed ledger system.

Referring to FIG. 2, the computing node 102 or server is at least one of a general or special purpose computer. In an embodiment, it operates as a single computer, which can be a hardware server, a workstation, a desktop, a laptop, a tablet, a mobile phone, a mainframe, a supercomputer, a server farm, and so forth. In an embodiment, the computer could run on any type of OS, such as iOS™, Windows™, Android™, Unix™, Linux™, and/or others. In an embodiment, the computing node 102 is in communication with network 108 and the distributed ledger system.

Referring to FIG. 2, the database 106 is accessible by the computing node 102. In an example, the database 106 resides in the computing node 102. In another example, the database 106 resides separately from the computing node 102. Regardless of location, the database 106 comprises a memory to store and organize data for use by the computing node 102.

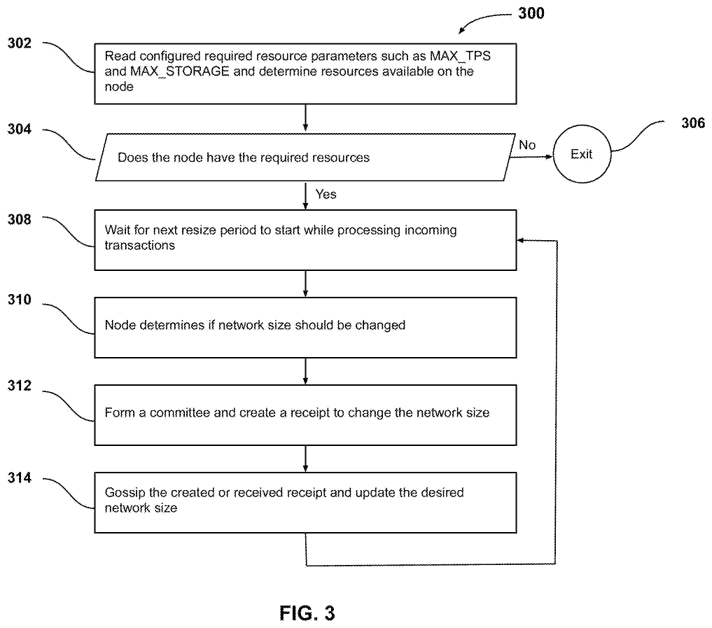

FIG. 3 depicts a flowchart 300 of the main autoscaling processing loop. The flowchart 300 details the primary steps and process a node takes to determine if the network needs to be scaled in a distributed ledger, according to an embodiment of the present invention. This figure includes all the critical steps for a method of autoscaling.

The flowchart begins at step 302, each node in the network is uniformly configured with values that specify the maximum transaction rate the node must process as well as the maximum storage capacity the node must provide through the MAX_TPS and MAX_STORAGE parameters. MAX_TPS is the transactions per second the node must be able to handle. MAX_STORAGE is the amount of persistent storage the node is expected to provide. Prior to joining the network, each node reads the configured resource parameters to determine if sufficient resources are available on the need. Configured resource parameters include, but are not limited to MAX_TPS and MAX_STORAGE.

At step 304, a resource verification occurs prior to joining the network. This involves the node assessing its resource capacity against predefined requirements. If the resources are insufficient, the process moves to step 306 in the flow chart's decision branch and the node exits the network. If adequate, the process advances to the transaction processing phase at step 308. This is a crucial verification step to ensure the node possesses the necessary resources to function effectively within the network.

At step 306, if the resources are found to be insufficient during the resource verification in the previous step 304, then the node exits the network. This step only occurs if a node finds its resources are insufficient when assessing its resource capacity against predefined requirements at step 304. Otherwise, this step is skipped.

At step 308, the node actively processes incoming transactions concurrently waiting for the next resize period to start. A resize period is a period in which nodes determine if the network size should be changed. This is a continuous operation where the node contributes to the network's functionality by handling transaction data whilst waiting for the next resize period in the process to occur.

At step 310, during the resize period, each node locally decides whether to propose adding more nodes, removing nodes, or maintaining the current amount of nodes based on the current values of the internal metrics, specifically, each node's current transaction load and its current storage used.

At step 312, during the resize period, a randomly determined subset of nodes are chosen to form a committee. All nodes decide on the same random committee by using the same seed for random number generation. This seed can be a number such as the hash of a block of transactions. The committee is responsible for making decisions about scaling the network, voting and producing a receipt on whether to add more nodes, remove nodes, or maintain the current amount of nodes. The randomness in determining the nodes ensures that decision making is equitably distributed, not influenced by a fixed set of nodes and that the decentralized nature of the network is maintained. Additionally, a receipt is created if a majority decision is achieved via voting. The receipt reflects the majority decision of the committee to add more nodes or remove nodes. Furthermore, the receipt formalizes the committee decision, serving as a record and a trigger for the agreed-upon action, and ensures transparency in the decision making process.

At step 314, the receipt created in step 310, is then disseminated across the network using a gossip protocol, leading to an update in the network size. A network size adjustment loop is triggered and the process then reverts back to step 308 and begins waiting for the next resize period to be initiated. This loop ensures the dynamic scalability of the network in response to operational demands and maintains the continuous operation of processing incoming transactions.

Each decision branch and loop in the flowchart 300 represents a self-contained process within the overall system, crucial for maintaining the network's efficiency and scalability.

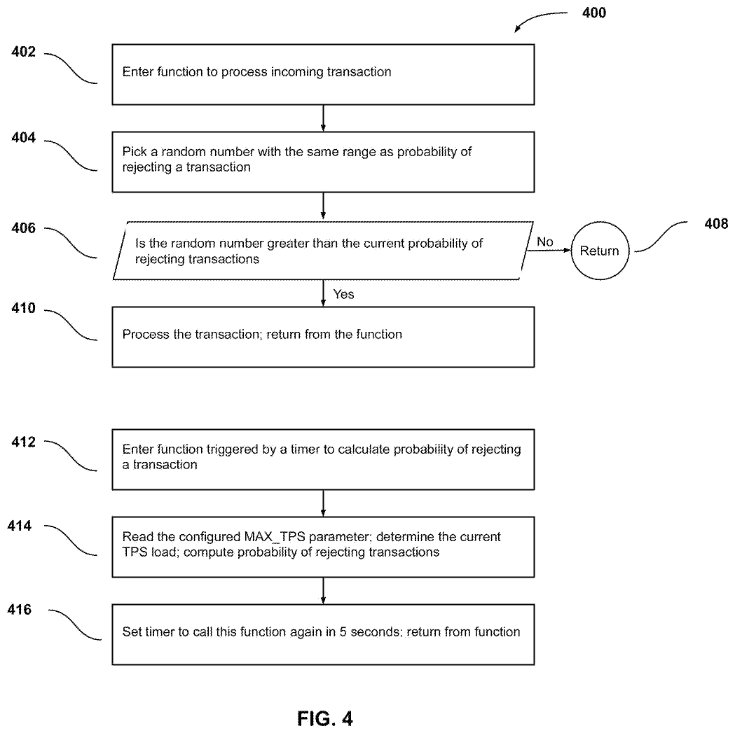

FIG. 4, shows a flowchart 400 that details a sequence of steps for transactions to be processed in a distributed ledger network, according to an embodiment of the present invention. FIG. 4 directly corresponds to FIG. 3, step 308 containing the step “Wait for the next resize period to start while processing incoming transactions”. FIG. 4 encapsulates nodes processing or rejecting incoming transactions. Furthermore, it delineates the continuous occurrence of transaction processing operations where the node contributes to the network's functionality by handling transaction data whilst waiting for the next period in the process to occur. FIG. 4 is divided into 2 functions: the transaction processing function and the timer-triggered function which work by processing incoming transactions while concurrently managing the rate of transaction processing based on the load. The transaction processing function makes individual decisions to process or reject transactions based on the relevant probabilities to ensure nodes do not get overloaded and maintain system balance whereas, the timer-triggered function periodically recalculates the probability of rejecting new transactions, ensuring efficient load management.

The flowchart begins at step 402, in which the node enters a function to process incoming transactions. The enter function indicates at which point control is transferred from the main autoscaling processing loop to the transaction processing function and initiates a set of transaction processing steps the program is designed to perform.

At step 404, a random number generator is used to pick a random number within the same range (such as 1 to 100) as the probability of rejecting a transaction. This step introduces a stochastic element into the transaction processing or rejection process ensuring that transaction handling is fair and not predictable.

At step 406, the node receiving the injected transaction conducts a rejection probability check to determine if it should reject the injected transaction. This checks if the random number generated for the transaction in step 404 is greater than the current probability of rejecting transactions. For example, let us assume that the probability of rejecting a transaction is 5%, the range used for the randomly generated number is 1 to 100 and the randomly generated number for this transaction is 15. The randomly generated number is compared to the probability of rejecting a transaction which is 5%, corresponding to the numbers less than 5. If the randomly generated number is less than 5 out of a range of 1 to a 100, then the transaction is rejected by the node. If the number is greater than 5, such as 15, then the transaction is processed. If the random number generated is greater than the current probability of rejecting transactions, then the node receives a “yes” decision where it proceeds to step 410, processes any transactions and returns from the function to the main autoscaling processing loop. If the random number generated is equal to or less than the current probability of rejecting transactions, then the node receives a “no” decision where it proceeds to step 408, rejects the transaction and returns from the function to the main autoscaling processing loop.

At step 408, each node rejects any transactions as the random number generated is equal to or less than the current probability of rejecting transactions and the node has received a “no” decision. The node then returns from the function to the main autoscaling processing loop, thus exiting the transaction processing procedure. Nodes only proceed to this step if they have received a “no” decision.

At step 410, each node processes any transactions as the random number generated is greater than the current probability of rejecting transactions and the node has received a “yes” decision. The node then returns from the function to the main autoscaling processing loop, thus exiting the transaction processing procedure.

At step 412, the node enters the time-triggered function. This step is initiated when a timer, set to a specific interval, expires. Upon being triggered, the nodes are called to execute the steps required to calculate the probability of rejecting a transaction. The use of a timer ensures that the function is executed periodically, allowing for regular monitoring and adjustment of the system's parameters. This mechanism provides a consistent and automated way to evaluate the node's load and adjust settings as needed, without manual intervention.

At step 414, the node reads its TPS threshold (MAX_TPS) and determines its current TPS load. Based on this, it calculates the probability of rejecting transactions. This is essential for dynamically adjusting the system's behavior based on real-time transaction load, ensuring that the system operates efficiently under varying loads. Additionally, the dynamic adjustment helps maintain system stability and performance, preventing overloads and ensuring fair processing of transactions.

At step 416, after completing the previous step, the function resets the timer for another 5 seconds, ensuring that it will be called again at this interval. 5 seconds is a configurable parameter and some implementations may use different values. Resetting the timer guarantees that the function will regularly assess the node's TPS load and probability of rejecting transactions, maintaining ongoing monitoring and adjustment. This continual loop of assessments at intervals, allows nodes in the distributed ledger to adapt to real-time changing conditions in the network, enhancing the overall performance and reliability of the system.

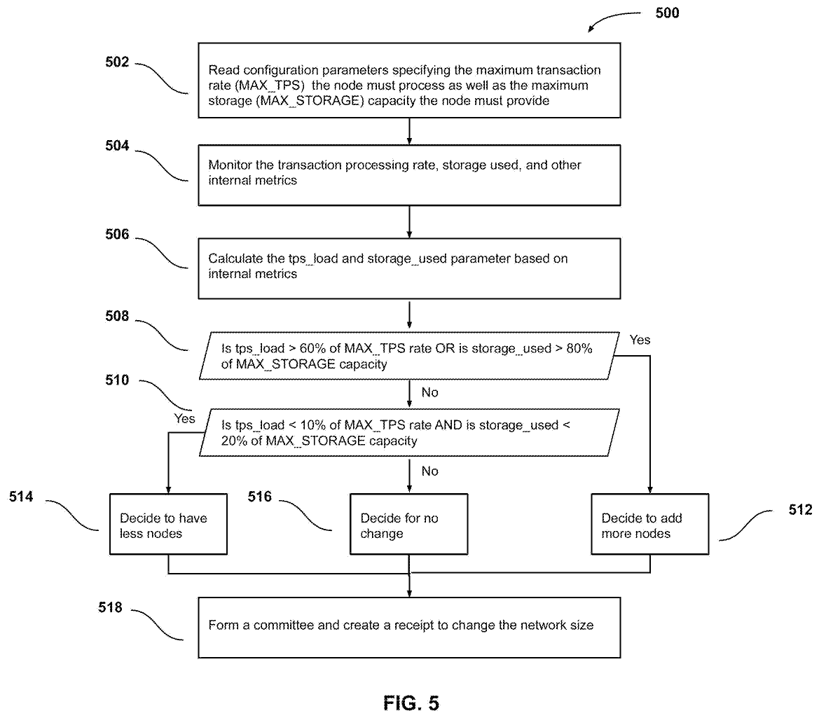

FIG. 5, shows a flowchart 500 that details a sequence of steps with various decision points within a sharded distributed ledger system for deciding changes in the network size, according to an embodiment of the present invention. FIG. 5 directly corresponds to step 310 in FIG. 3 containing the step “Node determines if network size should be changed”.

The flowchart begins at step 502, each node in the network is uniformly configured with values that specify the maximum transaction rate the node must process as well as the maximum storage capacity the node must provide through the MAX_TPS and MAX_STORAGE parameters. MAX_TPS is the transactions per second the node must be able to handle and MAX_STORAGE is the amount of persistent storage the node is expected to provide. Each node reads the configured values of these parameters. These parameters are distinct from tps_load and tps_storage which are the current measured values for TPS load and storage used.

At step 504, each node monitors multiple parameters such as the current transaction processing rate, the current storage used, number of transactions pending in the processing queue and the amount of time transactions are spending in the processing queue. Some implementations may use different internal metrics. Such parameters collectively form the internal metrics available to each individual node. Each node monitors these internal metrics in order to determine whether to propose adding more nodes, removing nodes, or maintaining the current number of nodes.

At step 506, each node calculates its current transaction load as the tps_load parameter and its current storage used as a storage_used parameter based on the aforementioned internal metrics mentioned in step 504. Nodes calculate the tps_load and the storage_used in order to determine each node's load or storage used. Each node's load is calculated between 0 and 100, with 0 being no load and 100 being maximum load. Additionally, each node's storage used is calculated between 0 and 100, with 0 being no storage and 100 being maximum storage used.

At step 508, each node conducts an overload assessment and determines whether its tps_load is greater than 60% of the maximum transaction rate or if storage_used is more than 80% of the maximum storage capacity. Both 60% and 80% represent adjustable pre-configured threshold variables that can be altered depending on the network requirements. If either condition is met, the process moves to the decision to add more nodes at 512 in the flow chart's decision branch. If no condition is met, the process moves to the underutilization assessment at step 510.

At step 510, each node conducts an underutilization assessment. If neither condition is met in 508, the node then checks if the tps_load is less than 10% of the maximum transaction rate (MAX_TPS) and storage_used is less than 20% of the maximum storage capacity (MAX_STORAGE). Both 10% and 20% represent adjustable pre-configured threshold variables that can be altered depending on the network requirements. If both conditions are satisfied, the process leads to the decision to have fewer nodes 514 in the flow chart's decision branch. If only one condition is met or no condition is met, the process moves to the decision for no change at step 516.

At step 512, the nodes make the decision to add more nodes based on either condition being met at step 508. The process then goes onto the next step to the committee formation and receipt formation in order to change the network size.

At step 514, the nodes make the decision to have less nodes if both conditions are met at step 510. The process then goes onto the next step to the committee formation and receipt formation in order to change the network size.

At step 516, the nodes make the decision not to change the network size. This only occurs if neither the overload or the underutilization conditions are met at step 508 and step 510. The process then goes to the next step to the committee formation and receipt formation in order to change the network size at step 518.

At step 518, periodically, a randomly determined subset of nodes are chosen to form a committee. This committee is responsible for making decisions about scaling the network, voting and producing a receipt on whether to add more nodes, remove nodes, or maintain the current amount of nodes. The randomness in determining the nodes ensures that decision making is equitably distributed, not influenced by a fixed set of nodes and that the decentralized nature of the network is maintained. Additionally, a receipt is created if a majority decision is achieved via voting. The receipt reflects the majority decision of the committee to add more nodes or remove nodes. Furthermore, the receipt formalizes the committee decision, serving as a record and a trigger for the agreed-upon action, and ensures transparency in the decision making process.

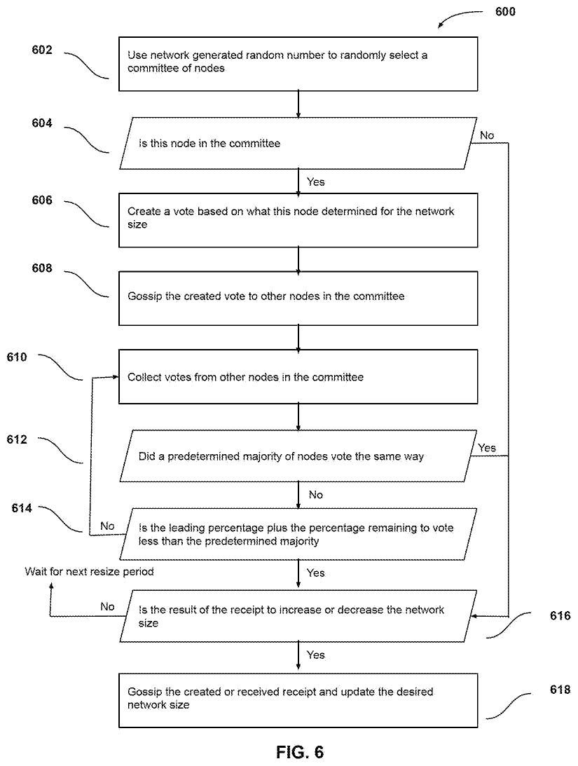

FIG. 6, presents flowchart 600, delineates the process sequence for committee formation and receipt production in a distributed ledger network, according to an embodiment of the present invention. FIG. 6 corresponds directly to step 312 in FIG. 3, this figure includes the critical step denoted as “Form a committee and create a receipt to change the network size”.

The flowchart begins at step 602, periodically, a randomly determined subset of nodes are chosen to form a committee. In order to accomplish this, a committee of nodes is randomly selected using a network generated random number. Random selection ensures fairness and unpredictability in the committee formation, preventing any bias or manipulation in the decision-making process regarding network size adjustment.

At step 604, each node checks whether it is part of the selected committee. This step is crucial for a node to acknowledge its role in the decision-making process. It ensures that only the designated committee nodes participate in the voting, maintaining the integrity of the consensus process. If a node is part of the selected committee, then it proceeds to step 606 in the flow chart's decision branch. If a node is not part of the committee, then it does not engage in other steps except for step 614 in which it checks if the result of the receipt is to increase or decrease the network size.

At step 606, each node within the committee creates a vote regarding its determination of the appropriate network size based on the assessment of network requirements. This step allows the decentralized network to make collective decisions about scaling, reflecting the current state and demands of the network.

At step 608, the created vote is disseminated via a gossip protocol to other nodes in the committee in order to gain an informed consensus. This ensures transparency and allows for rapid dissemination across the network.

At step 610, votes from other committee nodes are collected and aggregated. Collecting votes from committee members is crucial for aggregation of the individual decisions of each node in the committee, in order to form the network scaling decision. Nodes from step 614 can return to this step if they receive a “no” decision.

At step 612, the process checks if a predetermined majority of nodes voted in the same way. This step validates that a predetermined majority consensus has been reached amongst each node in the committee, ensuring that any decision made reflects the majority opinion, which is vital for the democratic decision-making process in a decentralized network. If a predetermined majority consensus has been reached amongst each node in the committee, then the node proceeds to step 616. If a predetermined majority consensus has not been reached amongst each node in the committee, then the node proceeds to step 614.

At step 614, a check occurs to determine whether the leading voting percentage plus the percentage remaining to vote is less than the predetermined majority. The predetermined majority is an alterable configuration threshold. This allows nodes to know whether the remaining vote could still change the majority decision and thus alter the outcome of the vote. If the leading voting percentage plus the percentage remaining to vote is less than the predetermined majority, then the process goes to step 616. If the leading voting percentage plus the percentage remaining to vote is equal to or greater than the predetermined majority, then the process loops and reverts to the votes from other committee nodes being collected and aggregated at step 610 in the flow chart's decision branch to allow for additional nodes to participate and potentially reach a consensus.

At step 616, a further check occurs to determine whether the result of the receipt is to increase or decrease the network size. If the result of the receipt is to either increase or decrease the network size, then the node proceeds to step 618. If the result of the receipt is neither to increase or decrease the network size and therefore to maintain the same network size, then the nodes continue to wait for the next resize period and will start the process again from the beginning.

At step 618, after passing the node participation check by achieving the required vote consensus, a receipt is created and disseminated via a gossip protocol across the entire network, resulting in an update to the desired network size. Creating and disseminating a receipt of the decision ensures that the entire network is updated with the new scaling decision, facilitating a uniform and coordinated change in the network's size.

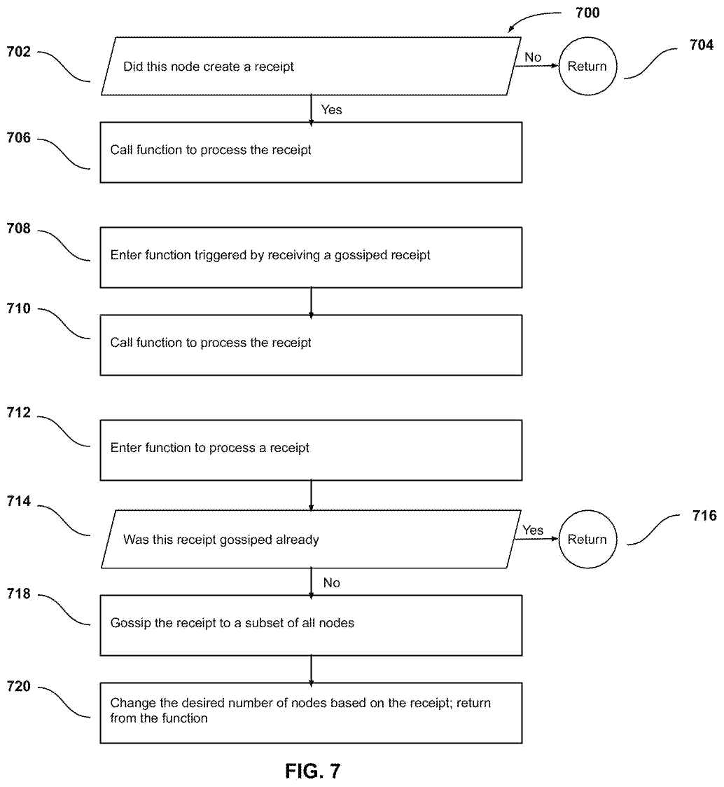

FIG. 7, shows a flowchart 700 that delineates the process for disseminating via gossip a receipt in order to scale the network in a distributed ledger network, according to an embodiment of the present invention. FIG. 7 directly corresponds to FIG. 3, step 314 containing the step “Gossip the created or received receipt and update the desired network size”. It is divided into 3 functions, the first function exclusively pertains to nodes that created the receipt in the committee. The second function consists of a 2 step process exclusively pertaining to nodes that did not create the receipt but received the receipt via a gossip protocol. The final step of both the aforementioned functions initiates the entering of a function for nodes to process the receipt, gossiping it to a subset of all nodes, changing the desired number of nodes based on the receipt and then returning from the function and exiting the receipt gossiping process.

The flowchart begins at step 702, in which each node checks if it has created a receipt. Each node has the capacity to do this autonomously and automatically. This step ensures that only the node which created the receipt can process it further and therefore prevents unnecessary processing by nodes not involved in the receipt creation, enhancing overall network efficiency. If a node performs the check and receives a “yes” decision, affirming it has created a receipt, then the node proceeds to step 706. If a node performs the check and receives a “no” decision, affirming it has not created a receipt, then the node proceeds to step 704.

At step 704, nodes which had performed the check and received a “no” decision, affirming it had not created a receipt, return from the function to the main autoscaling processing loop, thus exiting the receipt creation checking function. This receipt creation checking function, ensures that only the originating node or those that have received the gossiped receipt process it further.

Step 706 is the final step in the function. Nodes call a function in order to process the receipt. This function allows for the furtherance of the processing of the receipt, gossiping it and eventually changing the size of the network.

Step 708, pertains to nodes that did not create the receipt but received it via gossip, they enter a function triggered by receiving the receipt via gossip.

At step 710, nodes that did not create the receipt but received it via gossip, call a function to process the receipt. This function allows for the furtherance of the processing of the receipt, gossiping it and eventually changing the size of the network.

At step 712, the node enters a function to process the receipt. Then sequentially proceeds to other operations such as gossiping the receipt to a subset of all nodes, changing the desired number of nodes based on the receipt and finally returning the node from the function and exiting back to the main autoscaling process loop. This allows the network to validate and act upon the instructions contained within the receipt, ensuring that all relevant nodes are updated and in agreement on network size adjustment.

At step 714, the nodes check if the receipt was already gossiped previously. If the receipt was not gossiped previously, then nodes proceed to step 718 and gossip the receipt to a subset of all nodes. If the receipt was already gossiped, then nodes proceed to step 716 and gossip the receipt to a subset of all nodes. Nodes check in order to know which nodes have gossiped the receipts already. This prevents nodes from re-gossiping already gossiped nodes which squander network resources.

At step 716, nodes which had already gossiped the receipt return from the function to the main autoscaling processing loop, thus exiting the gossiping receipt process. This ensures that the additional network resources are not wasted on re-gossiping already gossiped receipts.

At step 718, the receipt is gossiped to a subset of all nodes. This allows the effective dissemination of the network, crucial for achieving network-wide consensus. Gossiping to a subset of all nodes, rather than all nodes, prevents network saturation, allows more effective long-term scalability and achieves rapid propagation.

At step 720, based on the receipt, nodes adjust the network to the desired number of nodes. Then nodes return from the function to the main autoscaling processing loop, thus exiting the gossiping receipt process. This process allows the autoscaling of the network size in response to the current needs and conditions of nodes and the network, which maintains optimal network performance and resource utilization.

What is claimed is:

1. A computer-implemented method for autoscaling in a distributed ledger, comprising the steps of:
determining based on transaction throughput and account storage, at each node in a computer network, if the network size should be changed;
using a network generated random number to select a randomized subset of nodes in the computer network;
forming a network connected committee of the randomized subset of nodes in the computer network;
disseminating, via a network communication protocol to other nodes in the committee, a vote to decide on changing the network size;
collecting votes to create a receipt recording a change in the network size;
disseminating, via a network communication protocol, said receipt to all nodes in the network;
and updating the network to the desired size based on the receipt.

2. The method of claim 1, wherein the distributed ledger system employs dynamic state sharding allowing the transaction throughput and storage capacity of the network to increase or decrease proportional to the number of nodes in the distributed ledger.

3. The method of claim 1, further comprising the step of:
configuring each node uniformly with predetermined values that specify the maximum transaction rates and maximum storage capacities for each node;
where the node does not join the network if the node determines it does not have insufficient resources based on the preconfigured values.

4. The method of claim 1, wherein nodes can reject injected transactions based on the internal metrics showing an increased load.

5. The method of claim 4, wherein the determination of rejecting a transaction is probabilistic.

6. The method of claim 1, wherein the communication protocol is a gossip protocol.

7. The method of claim 1, wherein the communication protocol is a broadcast protocol.

8. The method of claim 1, wherein the communication protocol is a direct message transfer protocol.

9. A computer-implemented method for transaction processing in a distributed ledger, comprising the steps of:
reading from a computer memory or disk storage preconfigured parameters specifying maximum transaction processing capacity;
determining one or more internal metrics based on transaction processing load;
computing, by a processor, the probability of rejecting transactions based on preconfigured parameters and internal metrics;
generating a random number within a predefined range corresponding to a probability of rejecting an injected transaction;
rejecting or processing the transaction based on comparing the generated random number with a current probability threshold for rejecting transactions;
and periodically updating the one or more internal metrics based on transaction processing load.

10. A system for autoscaling in a distributed ledger, comprising:
a plurality of nodes interconnected within a network,
wherein each node includes a memory storing one or more program modules,
wherein each node is configured to execute the program modules to perform one or more operations,
wherein each node employs the method of claim 1.

11. The system of claim 10, wherein the sharded distributed ledger is composed of a different number of computers.

12. The system of claim 10, wherein the sharded distributed ledger is composed of a different number of shards.
